(19) United States
(12) Patent Application Publication
(10) Pub. No.: US 2013/0119230 A1
(43) Pub. Date: May 16, 2013

(54) MOULD TOOLS OF FOAMED FERROUS/NICKEL ALLOY

(71) Applicant: Thomas Corden, West Bridgford (GB)

(72) Inventor: Thomas Corden, West Bridgford (GB)

(73) Assignee: UMECO STRUCTURAL MATERIALS (DERBY) LIMITED, Heanor, Derbyshire (GB)

(21) Appl. No.: 13/699,364

(22) PCT Filed: Mar. 23, 2011
(86) PCT No.: PCT/GB11/00407

§ 371 Date: Jan. 28, 2013

(30) Foreign Application Priority Data
May 25, 2010 (GB) 1008693.2

(51) Int. Cl. B29C 33/38

(52) U.S. Cl. CPC B29C 33/3814
USPC 249/114.1; 427/135

(57) ABSTRACT

Mould tools (10) particularly for use in moulding curable resinous composite materials, such as fibre-reinforced resinous materials, having a body (14) comprising a foamed ferrous/nickel alloy such as FeNi36, FeNi42 and/or FE-330Ni-4.5Co. The body (14) can be made of a single unit or of a plurality of units that would typically be secured together. A tool surface (12) is declined on a tool surface layer (20) of the body (14). The tool surface layer (20) can comprise a cured resinous material.

The present invention relates to foamed ferrous/nickel alloys, and particularly but not exclusively to the use of such alloys in mould tools and other structures.

Conventionally, mould tools, particularly those used in moulding curable resin composite materials, are produced from a pattern hand-shaped or machined to a required geometry. A release agent is typically applied and a tool skin cured on this. The cured tool skin is then released from the pattern and a backing structure applied to support the skin. Mould tools produced in this way suffer from some significant drawbacks. For instance, even with the use of sophisticated computer modelling and predictions of the thermal expansion and chemical shrinkage of the materials used in the tool skin as they cure, there is a limit as to how accurately the tool skin can be moulded. Currently there is a trend for composite mould tools of ever increasing size and accuracy and this conventional method of manufacture often proves unsatisfactory.

There is also an increasing demand for mould tools suitable for automated deposition of material thereon, such as by fibre winding and robotic tape placement. These processes generally require the mould tool to have significant structural stiffness. This tends to be particularly so where the mould tool is of a mandrel type that requires rotation, such as during tape placement.

These two main requirements for increased accuracy and structural stiffness have prompted the development of alternative mould tools wherein carbon foam or ceramic foam are used as the main structure of the tool. Typically, the foam structure is shaped and a tool skin applied, carefully profiled and finished to offer a mould surface. Such mould tools can provide more accurate mould surfaces and significantly increased structural stiffness in comparison to the aforesaid shell-type mould tools with an added backing structure.

However, there are significant disadvantages of using such foam materials in this way. Both carbon and ceramic foam materials tend to be brittle and are inherently vulnerable to cracking and delamination from the tool skin. Efforts to compensate for this require considerable thought and engineering to produce the mould tools, thus adding to the expense of such mould tools. With carbon foams there are issues concerning combustibility and moisture absorption. Also, both carbon and ceramic are insulating materials and therefore tools made from these can take a long time to heat up and cool down, which can present problems in certain applications.

There are also many structures that need or benefit from exhibiting no or relatively little significant expansion when subjected to elevated temperatures. Often such structures are manufactured from dense, heavy materials.

According to the present invention there is provided a mould tool comprising a tool surface on which material can be located for moulding and a body on which the tool surface is located, the body comprising a foamed ferrous/nickel alloy.

The foamed ferrous/nickel alloy may have a coefficient of thermal expansion of between −3 and +10 ppm/° C. The ferrous/nickel alloy may have a coefficient of thermal expansion of between 0 and 5 ppm/° C.

The ferrous/nickel alloy may comprise Invar, such as FeNi36 or 64FeNi, that contains approximately 64% iron and 36% nickel. A small amount, typically in the order of 0.2%, of carbon is generally present. Alternatively or in addition, the ferrous/nickel alloy may comprise one or more of FeNi42 (NILO alloy 42) or Inovco (Fe-33Ni-4.5Co).

Preferably the ferrous/nickel alloy comprises between 30% and 50% of nickel by weight.

The density of the ferrous/nickel alloy foam may be between 150 and 800 kg/m³, and preferably between 150 to 400 kg/m³. The foamed ferrous/nickel alloy may have an open-cell structure.

The body may comprise most if not all of the volume of the mould tool.

The body may comprise a single unit of foamed ferrous/nickel alloy, which may be shaped to carry the tool surface. Alternatively, the body may comprise a plurality of units, or blocks, of foamed ferrous/nickel alloy, some or all of which may be shaped to carry the tool surface. The units may be securely held together, such as by metal joining techniques including welding, brazing, soldering, sintering and/or by bonding with bonding agents such as adhesives, pastes and adhesive films.

A tool surface layer may define some or all of the tool surface. The tool surface layer may be metallic and may comprise one or more ferrous/nickel alloys, which may be the same ferrous/nickel alloy(s) comprised in the body.

The tool surface layer may comprise a cured resinous material, and may comprise a cured fibre-reinforced resinous composite material such as fibre-reinforced epoxy resin, fibre-reinforced BMI resin and suchlike.

The tool surface layer may be secured directly to the body, such as with one or more mechanical fixings, bonding means such as adhesives, resins, polymers, elastomers and/or by the direct application or deposition of the tool surface layer to the body.

The tool surface layer may be in the form of a skin over at least part of the body.

The tool surface layer may comprise a machined or otherwise accurately profiled surface that defines at least in part the aforesaid tool surface.

The body may comprise a seal over some or all of the surface(s) thereof on which the tool surface layer is secured. The seal may comprise one or more of a resin, polymer, elastomer and may be in the form of a layer.

The mould tool may be arranged to receive a heat transfer medium therethrough, to provide for the selective control of the temperature of the mould tool. The mould tool may comprise one or more connecting arrangements that enable the body to be connected to a heat transfer medium supply, and enable the selective introduction and preferably removal of heat transfer media, such as hot and/or cold water, air or other suitable fluids, into the open-cell structure of the body to enable selective heating and cooling of the body.

According to a second aspect of the present invention there is provided a mould tool body comprising a foamed ferrous/nickel alloy.

The mould tool body may comprise a body as described in any of the preceding fifteen paragraphs.

According to a third aspect of the present invention there is provided a method of manufacturing a mould tool, the method comprising forming a tool body comprising foamed ferrous/nickel alloy and providing a tool surface on the tool body on which material to be moulded is locatable.

The method may comprise the manufacture of a mould tool as described in any of paragraphs seven to twenty above.

In embodiments where the tool surface layer comprises a resinous material the tool surface layer may be located on the body in an uncured or part-cured state and then cured in position on the body.

In embodiments where the tool surface layer is metallic, the layer may be formed on the body by deposition techniques including one or more of thermal spraying, electroplating, CNC weld deposition, laser powder sintering.

According to a fourth aspect of the present invention there is provided a method of manufacturing a moulded article, the method comprising placing material to be moulded on a mould surface of a mould tool comprising a body of foamed ferrous/nickel alloy and subjecting the material to conditions to set the material on the mould surface.

The material to be moulded may be curable and the method may involve subjecting the material to conditions to cure the material.

According to a fifth aspect of the present invention there is provided a foamed ferrous/nickel alloy for use in the manufacture of a foamed body, such as but not exclusively a body for a mould tool.

The foamed ferrous/nickel alloy may be as described in any of paragraphs seven to twenty above.

Embodiments of the present invention will now be described by way of example only, with reference to the accompanying drawings in which:

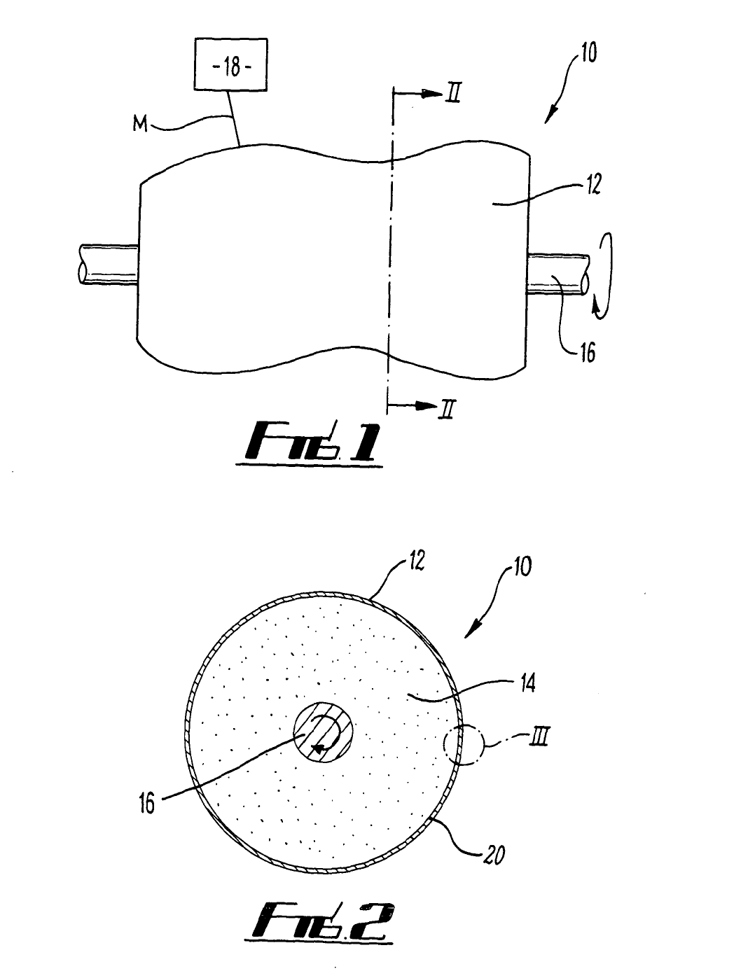

FIG. 1 is a diagrammatic illustration of a mould tool of the present invention;

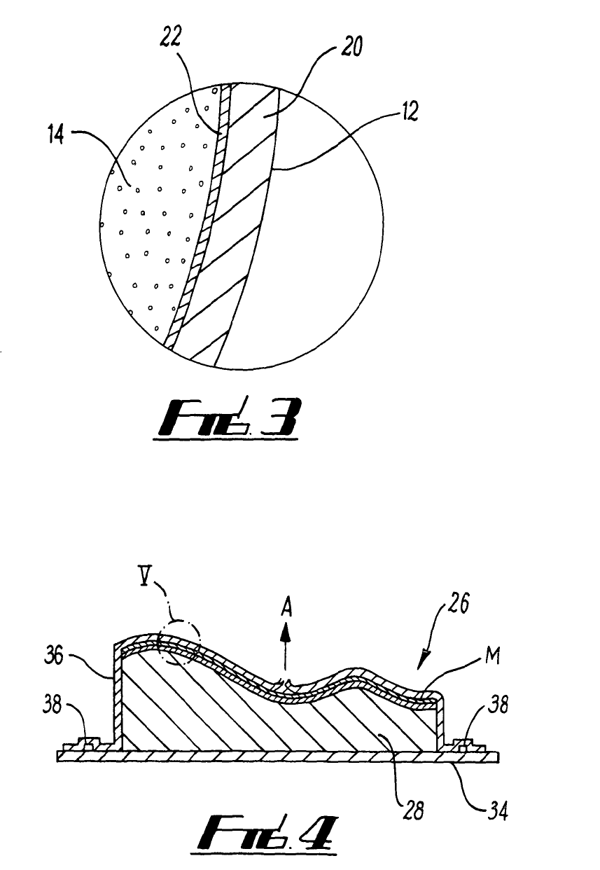

FIG. 2 is a diagrammatic cross-section of the mould tool of FIG. 1 along the line II-II;

FIG. 3 is an enlarged cross-sectional view of the area III of FIG. 2;

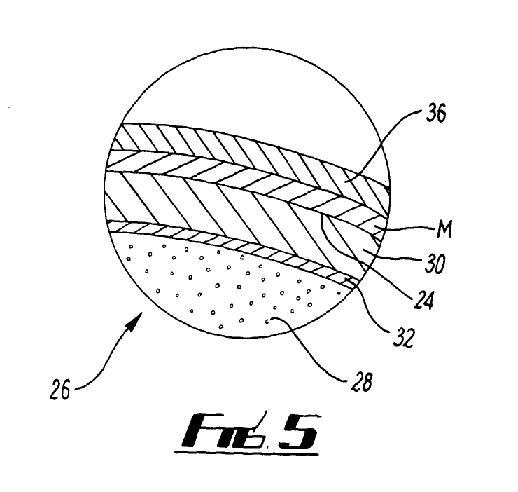

FIG. 4 is a diagrammatic cross-sectional illustration of a mould tool of the present invention in the manufacture of a moulded article; and

FIG. 5 is an enlarged cross-sectional view of area V of FIG. 4.

Referring to the drawings, there is provided mould tools, mould tool bodies, methodology for manufacturing mould tools, methodology for manufacturing moulded articles, foamed ferrous/nickel alloys and methodology for manufacturing foamed ferrous/nickel alloys. Mould tools according to the present invention have a body comprising a foamed ferrous/nickel alloy.

FIGS. 1 to 3 illustrate a mould tool 10 in the form of a rotatable mandrel having a tool surface 12 on which material M can be located for moulding and a body 14 on which the tool surface 12 is located, the body 14 comprising a foamed ferrous/nickel alloy.

A shaft 16 runs centrally through the mould tool 10 about which the mould tool 10 is selectively rotatable. Rotation is driven by conventional means (not shown).

Mould tools of the present invention find particular application in the moulding of curable resinous composite materials, such as fibre-reinforced resinous materials. It will be appreciated however that other suitable materials can be formed on the mould tools of the present invention.

The mould tool 10 can be used in the automated deposition of material M onto the tool surface 12 in accordance with conventional techniques such as fibre winding and/or robotic tape placement. The size of the mould tool 10 is determined by the size of the article to be moulded or formed thereon. Often, such automated techniques are used in the manufacture of very large articles, many metres in length, and this requires the tool or mandrel to have significant structural stiffness to cope with the rotational forces imposed on it. The mould tools of the present invention including the mould tool 10 enjoy a very significant inherent structural stiffness due to the inherent structural stiffness of the foamed ferrous/nickel alloy body. Further, in such large scale applications the relatively low density of the foamed ferrous/nickel alloy offers significant advantage in helping reduce the weight of the mould tool 10, which in addition to offering generally improved handling and safety characteristics also renders the tool 10 more manoeuvrable, having relatively low inertia and thus enabling the movement of the tool 10 to be more controllable than conventional tools of equivalent size.

The material M is illustrated as a fibre or tape extending from a fibre/tape source 18 to the tool surface 12.

Typically the source 18 would comprise a robotic head that moves relative to the mould tool 10 to provide for controlled winding of the fibre/tape onto the tool surface 12, as the mould tool rotates about the central shaft 16.

The body 14 of the mould tool 10 in certain embodiments of the present invention is formed from the ferrous nickel alloy Invar.

Invar can be sourced and used in various grades. A common grade FeNi36 (also known as 64FeNi) finds application in the present invention. FeNi36, sometimes called Invar 36, typically comprises about 64% iron and 36% nickel, with a small amount (typically 0.2%) of carbon.

Invar typically has a coefficient of thermal expansion (CTE) in the order of 1.2 ppm/° C. Generally the purer the grade of Invar (ie the less cobalt present) the lower the CTE. Ferrous/nickel alloys having a coefficient of thermal expansion of between −3 and +10 ppm/° C. are within the scope of the present invention. In preferred embodiments the CTE is between 0 and 5 ppm/° C.

In certain embodiments, alternative ferrous/nickel alloys may be used, such as FeNi42 (NILO alloy 42) and/or Inovco (Fe-33Ni-4.5Co). In certain embodiments the body may comprise a number or mix of the aforesaid alloys.

Typically the ferrous/nickel alloys used in the present invention comprise between 30% and 50% of nickel by weight.

The density of the ferrous/nickel alloy foam is typically between 150 and 800 kg/m³ and in certain embodiments between 150 and 400 kg/m³. The foamed ferrous/nickel alloys used typically have open-cell structures.

The body 14 comprises the bulk and typically the vast majority of the volume of the mould tool 10. The body 14 can be made up of a single unit or block or in certain embodiments made up of a number of units or blocks that would typically be secured together, as will be explained.

The tool surface 12 is defined on a tool surface layer 20 on the body 14. The tool surface layer 20 comprises a layer of cured resinous composite material and conventional tool skin materials for mould tools can be used, such as fibre-reinforced epoxy resins, fibre-reinforced BMI's, cyanate esters, phenolics, thermoplastics. The fibre-reinforcements again include known fibre-reinforcements such as carbon fibre, glass fibre and the like.

An intermediary layer 22 is provided between the body 14 and the tool surface layer 20. This intermediary layer can be a sealing layer to seal the outer surface of the body 14, to facilitate secure location of the tool surface layer 20 to the body 14. The intermediary layer 22 can provide a resilient interface between the tool surface layer 20 and the body 14, allowing slight relative movement between the body 14 and the tool surface layer 20, helping prevent delamination of the layer 20 from the body 14. The intermediary layer 22 can comprise an elastomeric material.

It will be appreciated that in certain embodiments an intermediary layer 22 may not be provided.

The tool surface layer 20 is illustrated as a single layer, but in certain embodiments the layer 20 can comprise a laminate of a plurality of layers.

In certain embodiments the tool surface layer 20 is metallic and in preferred such embodiments comprises a ferrous/nickel alloy. In certain embodiments the ferrous/nickel alloy of the tool surface layer 20 is the same as that of the body 14, although typically the tool surface layer 20 would not be foamed. In alternative embodiments the alloys may differ, but it is generally preferable that they have closely similar CTE's to help avoid issues of delamination of the tool surface layer 20 from the body 14.

The metallic tool surface layer 20 can be bonded to the body 14, in which case the intermediary layer 22 can comprise a bonding agent such as an adhesive, resin, polymer or paste.

Alternatively or in addition the metallic tool surface layer 20 may be mechanically fixed to the body 14, such as by way of threaded fixings, rivets and the like.

In certain embodiments of the invention, the tool surface layer 20 may be formed or deposited directly on the body 14, such as by way of thermal spraying, electroplating, CNC weld deposition, laser powder sintering.

The tool surface layer 20 is typically machined, such as by way of CNC machining, polished or otherwise finished to provide the tool surface 12.

The mould tool 10 can be formed with great precision. The body 14 is shaped to reflect the desired profile of the tool surface 12, albeit to be slightly smaller than the finished mould tool 10. The tool surface layer 20 is then applied to the body 14 using the desired techniques discussed above and then the tool surface layer is finished to produce a highly accurate tool surface 12.

The use of foamed ferrous/nickel alloys for the body 14 provides mould tools of the present invention with particular advantage. Such foams are ductile and it is found that there are little or no problems with regard to cracking of the body 14. The CTE's of the ferrous/nickel alloys of the present invention closely match the CTE's of conventional curable resinous materials that can be moulded on the mould tool 10, such as fibre-reinforced epoxy resins, BMI resins, phenolic resins, cyanate ester resins, thermoplastic resins, benzoxazines and the like.

In embodiments where the tool surface layer 20 comprises resinous composite materials, again the similarity in CTE's of the materials of the tool surface layer 20 and the body 14 helps to prevent delamination of the tool surface layer 20 from the body 14. As indicated above, where necessary or preferred, an intermediate such as an elastomeric layer may be used to provide further resistance to delamination.

It will be appreciated that such resinous tool surface layers 20 would typically be cured in situ on the body 14. However in certain embodiments such tool surface layers may be cured or at least part-cured remotely from the body 14 and then introduced to the body 14 to be secured thereon.

In those embodiments where the tool surface layer 20 is metallic, the use of ferrous/nickel alloys means that the CTE's of the body 14 and the layer 20 are closely similar, offering the mould tool the advantage this brings. Further, the CTE of the tool surface layer 20 will be closely similar to the material M typically being moulded thereon.

The ferrous/nickel alloys produce a body for the mould tools of the present invention that is rigid and offers significant structural stiffness enabling the mould tools of the present invention to be used in large scale automated processes, such as fibre and tape placement, to produce large moulded articles. The mould tool 10 is illustrated for such use.

The ferrous/nickel alloys provide the body 14 with high thermal conductivity. This can have advantage in applications where it is desired to carefully control the heat of the mould tool and where relatively rapid heating and/or cooling of the mould tool is required or is advantageous.

In certain embodiments of the present invention a heat transfer medium such as air, liquid such as water, can be circulated through the open-cell structure of the body 14 to provide for controlled heating and/or cooling of the body 14 and thus the mould tool 10.

The present invention also provides a method of manufacturing a mould tool, the method comprising forming a tool body 14 comprising foamed ferrous/nickel alloy and providing a tool surface on the tool body on which material to be moulded is locatable.

The body 14 can be formed from a single unit or block of ferrous/nickel alloy but typically for larger mould tools the body 14 would be constructed from a plurality of units, typically blocks of foamed ferrous/nickel alloy. The general shape of the body 14 would be built up by placing such blocks adjacent to one another and securing them together. Various techniques can be used to secure the units together, such as conventional metal joining techniques like brazing, welding, soldering and sintering, and/or they could be secured together using bonding materials such as adhesives, pastes, resins or film adhesives.

Once a sufficient volume of foamed ferrous/nickel alloy has been produced, the assembly of foamed ferrous/nickel alloy blocks can then be shaped to the general desired profile of the body. Conventional cutting techniques such as CNC machining have been found suitable for shaping the foamed ferrous/nickel alloy.

As indicated previously, the tool surface layer 20 is then applied either directly or via an intermediary layer 22 to the body 14, cured if necessary, and where appropriate finished to provide the mould tool 10.

The present invention also provides a method of manufacturing a moulded article involving placing material M to be moulded on a mould surface 12, 24 of a mould tool 10, 26, the mould tool 10, 26 having a body of foamed ferrous/nickel alloy 14, 28, and subjecting the material M to conditions to cure the material on the mould surface 12, 24.

FIGS. 1 to 3 illustrate material M being moulded on a mould tool 10 by way of an automated process as discussed above.

FIGS. 4 and 5 provide a diagrammatic illustration of material M being moulded on a mould tool 26 according to alternative embodiments of the present invention. The mould tool 26 is a simple static mould tool comprising a body 28 of foamed ferrous/nickel alloy (generally as described with reference to numeral 14 above), a tool surface layer 30 (generally as described above with reference to numeral 20) and an intermediary layer 32 (generally as described above with reference to numeral 22). The tool is located on a support 34 and the material M to be moulded is carefully located, such as by hand, on the mould surface 24. The mould tool 26 and the material M is then enclosed beneath a vacuum membrane 36 which is sealed against the support 34 by peripheral seals 38 so that material M and the mould tool 26 are enclosed with a vacuum integral seal beneath the membrane 36. The material is then subjected to cure conditions, such as elevated temperatures, and air and other volatiles produced during cure are drawn out from beneath the membrane 36, as illustrated diagrammatically by the arrow A.

This moulding technique is conventional, but advantages offered by the mould tool 28 of the present invention are that the mould tool can rapidly heat up and cool down to closely match the temperature variation of cure conditions and the material M moulded thereon. This can help to control expansion characteristics of the various materials during the cure process and can also enable relatively swift turn around time for the reuse of the mould tool.

The present invention also provides a foamed ferrous/nickel alloy for use in the manufacture of a foamed body. The foamed body may comprise a body for a mould tool, but also within the scope of the present invention the foamed body may comprise the whole or a part of a structure or component where the properties of relatively low coefficient of thermal expansion and relatively low density (and thus weight) of the foamed ferrous/nickel alloy provide advantage and can be enjoyed. For example, the foamed ferrous/nickel alloys of the present invention can be used for satellite structures that often experience considerable and rapid changes in ambient temperature. The conductive nature of the foamed alloys of the present invention enable the structure to quickly heat up and cool down without significant and potentially damaging or otherwise problematic expansion of the foam body. The low density and thus relatively light weight of the foamed ferrous/nickel alloys of the present invention also render them advantageous in such structures.

Other structures in which the foamed ferrous/nickel alloys of the present invention find utility is in measurement structures and apparatus such as optical benches, meteorological instruments and suchlike, where the lack of significant expansion and thus potential warping of the structures or components thereof is important. Other applications include astronomy apparatus and instruments, such as mirrors and reflectors for astronomical telescopes.

It will be appreciated that there are very many structures or structural components where it is important and/or desirable for there to be limited or no significant thermal expansion during use and the foamed ferrous/nickel alloys of the present invention lend themselves to many such applications. The conductive nature, the ductile characteristics and the relatively low density of the foamed ferrous/nickel alloys provide further significant advantage in certain applications, such as (but not limited to) those discussed above.

The foamed ferrous/nickel alloys can be manufactured using any suitable technique One method comprises applying a slurry of ferrous/nickel alloy particles dispersed in a carrier substrate to a destructible support foam, allowing the particles to become generally fixed in position on the support foam and destroying the support foam.

The ferrous/nickel alloy foams of the present invention can be produced by forming a slurry comprising a carrier or base substrate in which is suspended particles of the ferrous/nickel alloy, typically in fine metal powder form.

The size of ferrous/nickel alloy particles can have a bearing on the structure of the foamed ferrous/nickel alloy produced therefrom, and typically it is preferred that particles of less than 10 microns in average diameter are used to provide a satisfactory foam structure.

Thickening/suspending agents can be added if necessary and a dispersant can be added to facilitate the production of a homogenous mix.

The percentage weight of the ferrous/nickel alloy particles, per unit volume of the carrier substrate can be controlled, and it is found that controlling this can help to control the density of the foamed ferrous/nickel alloy formed. Typically the slurry will comprise between 45% and 60% of ferrous/nickel particles per volume. The carrier can be any suitable medium.

The density of the support foam used can be selected to help control the density of the foamed ferrous/nickel alloy. The shape and size of the support foam will also determine the shape and size of foamed ferrous/nickel alloy produced and so can be controlled to produce desired shapes and configurations of foamed ferrous/nickel alloy.

It is also found that the density and structure of the foamed ferrous/nickel alloy depends upon the amount of ferrous/alloy particles deposited onto the support foam, and this in turn can be determined by the number of times the slurry is applied to the support foam (as well as the loading of alloy particles in the slurry and the viscosity of the slurry). Typically, the support foam will be dipped in the slurry and excess removed, such as by rollers, to help ensure the foamed alloy has a good foam structure.

Typically, once a predetermined size, density and shape of support foam has been selected and the desired density and viscosity of slurry produced, the slurry is introduced to the support foam. As indicated above, this may be a multi-stage process and may simply involve dipping the support foam into a bath of slurry so that the slurry impregnates the foam (preferably fully impregnates) and then any excess removed. After each stage, the slurry would generally be allowed to dry, which could involve gelling of the slurry on the support foam. Once the required loading of ferrous/nickel alloy has been achieved, the support foam can be subjected to a moulding or shaping step so that it assumes a shape that resembles or otherwise facilitates the formation of the foamed ferrous/nickel alloy body. The support foam is then destroyed. Typically this is done using a combustion process in which the support foam is burnt off. Typically the support foam would comprise a combustible plastics foam, such as polyurethane foam. Typically the support foam would be removed at temperatures in the order of 550° C., well below the melting point of the foamed ferrous/nickel alloy. The ferrous/nickel alloy particles would then be sintered on the support foam. Sintering can take place as a single stage, and in an N₂/H₂ gas mixture at 1250° C.

It is found that shrinkage can occur during sintering, and it is found that typically the degree of shrinkage decreases with the more highly loaded slurries. Shrinkage is however generally predictable and therefore can be controlled.

It has been found that the architecture of the foamed ferrous/metal alloy is more open and less defective when produced with slurries with relatively low ferrous/nickel alloy particle content. Slurries loaded to approximately 45% provide good foam architecture which not only provides for good properties for the material for use in moulding, but also facilitates the removal of the by-products of the combustion of the support foam during formation.

Alternative methods include bubbling gas through a melt of ferrous/nickel alloy, employing blowing or foaming agents, solid-gas eutectic solidification, foaming of powder compacts, mixing alloy powder or particles with soluble particles (such as NaCL)—fusing/sintering—then dissolving away the soluble particles, sintering of hollow spheres of alloy, electrodeposition of the alloy onto a support foam, such as a polymer foam, deposition from the gas or vapour phase, direct injection of gases to molten metal with enhanced viscosity, using foamable precursors, using gas forming particle deposition in semi-solid alloy and the like.

It will be appreciated that the method employed can affect the physical structure of the foam, eg whether it is open cell or closed cell, and the appropriate method can be chosen with such considerations in mind.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mould tool comprising a tool surface on which material can be located for moulding and a body on which the tool surface is located, the body comprising a foamed ferrous/nickel alloy.

2. A mould tool as claimed in claim 1, in which the foamed ferrous/nickel alloy has a coefficient of thermal expansion of between −3 and +10 ppm/° C.

3. (canceled)

4. A mould tool as claimed in claim 1, in which the ferrous/nickel alloy comprises Invar.

5-8. (canceled)

9. A mould tool as claimed in claim 1, in which the density of the ferrous/nickel alloy foam is between 150 and 800 kg/m³.

10. (canceled)

11. A mould tool as claimed in claim 1, in which the foamed ferrous/nickel alloy has an open-cell structure.

12. A mould tool as claimed in claim 1, in which the body comprises most if not all of the volume of the mould tool.

13. (canceled)

14. A mould tool as claimed in claim 1, in which the body comprises a plurality of units of foamed ferrous/nickel alloy, some or all of which are shaped to carry the tool surface.

15. A mould tool as claimed in claim 14, in which the units are securely held together by metal joining techniques and/or by bonding with bonding agents.

16. A mould tool as claimed in claim 1, in which a tool surface layer defines some or all of the tool surface.

17. A mould tool as claimed in claim 16, in which the tool surface layer is metallic.

18. A mould tool as claimed in claim 16, in which the tool surface layer comprises one or more ferrous/nickel alloys.

19. A mould tool as claimed in claim 16, in which the tool surface layer comprises the same ferrous/nickel alloy(s) comprised in the body.

20. (canceled)

21. A mould tool as claimed in claim 16, in which the tool surface layer comprises a cured fibre-reinforced resinous composite material.

22. (canceled)

23. A mould tool as claimed in claim 16, in which the tool surface layer is secured directly to the body by bonding means.

24. A mould tool as claimed in claim 16, in which the tool surface layer is secured directly to the body by the direct application or deposition of the tool surface layer to the body.

25. A mould tool as claimed in claim 16, in which the tool surface layer is in the form of a skin over at least part of the body.

26. A mould tool as claimed in claim 16, in which the tool surface layer comprises a machined or otherwise accurately profiled surface that defines at least in part the aforesaid tool surface.

27. A mould tool as claimed in claim 16, in which the body comprises a seal over some or all of the surface(s) thereof on which the tool surface layer is secured.

28. A mould tool as claimed in claim 27, in which the seal comprises one or more of a resin, polymer, elastomer.

29-31. (canceled)

32. A mould tool body comprising a foamed ferrous/nickel alloy.

33. A method of manufacturing a mould tool, the method comprising forming a tool body comprising foamed ferrous/nickel alloy and providing a tool surface on the tool body on which material to be moulded is locatable.

34. A method of manufacturing a mould tool as claimed in claim 33, in which the tool surface is provided by forming a tool surface layer on the body in an uncured or part-cured condition and cured in position on the body.

35. (canceled)

36. A method as claimed in claim 33, in which the tool surface layer is formed by one or more of thermal spraying, electroplating, CNC weld deposition, laser powder sintering.

37. A method of manufacturing a moulded article, the method comprising placing material to be moulded on a mould surface of a mould tool comprising a body of foamed ferrous/nickel alloy and subjecting the material to conditions to cure the material on the mould surface.

38. (canceled)

39. A body comprising foamed ferrous/nickel alloy.

40-45. (canceled)
